(19) United States
(12) Patent Application Publication
(10) Pub. No.: US 2015/0217462 A1
(43) Pub. Date: Aug. 6, 2015

(54) HERB SHEARS

(71) Applicant: Progressive International Corporation, Kent, WA (US)

(72) Inventor: Jennifer K. Cotter, Seattle, WA (US)

(21) Appl. No.: 14/609,974

(22) Filed: Jan. 30, 2015

Related U.S. Application Data
(60) Provisional application No. 61/934,938, filed on Feb. 3, 2014.

(51) Int. Cl. B26B 13/22; A47J 43/28; B26B 13/20

(52) U.S. Cl. CPC B26B 13/22; B26B 13/20; A47J 43/288

(57) ABSTRACT

A pair of herb shears includes blades that are sufficiently sturdy to trim herb stems, particularly including woody stems. The shears include a pair of opposing posts formed on the handles in which the posts join to form a channel as the handles are pivoted toward one another. The stem of an herb can be passed through the channel while applying a desired force against the stem, thereby stripping leaves away from the stem

### PRIORITY CLAIM

This application claims priority to U.S. provisional application Ser. No. 61/934,938 filed Feb. 3, 2014; the contents of which are incorporated by reference.

### FIELD OF THE INVENTION

This invention relates to scissors and shears, particularly for use in food preparation.

### BACKGROUND OF THE INVENTION

When cooking with leafy herbs and similar plant matter, it is often desirable to separate the leaves from the stems, and likewise to trim thicker woody stalks away from thinner, more tender portions of the stalks. Standard kitchen shears work well for trimming, but there is no available tool to aid in removing leaves from the stems.

### SUMMARY OF THE INVENTION

The present invention comprises shears having blades that are sufficiently sturdy to trim herb stems, particularly including woody stems. The shears include a pair of opposing posts formed on the handles in which the posts join to form a channel as the handles are pivoted toward one another. The stem of an herb can be passed through the channel while applying a desired force against the stem, thereby stripping leaves away from the stem.

### BRIEF DESCRIPTION OF THE DRAWINGS

Preferred and alternative examples of the present invention are described in detail below with reference to the following drawings:

FIG. 1 is a top plan view of a preferred pair of herb shears.

FIG. 2 is a top perspective view of a preferred pair of herb shears, shown with the blades pivoted apart.

FIG. 3 is an end view of a preferred pair of herb shears, shown looking toward the handles and with a leaf stripper positioned to form a large enclosed channel.

FIG. 4 is an end view of the herb shears of FIG. 3, shown with the leaf stripper forming a large intermediate channel.

FIG. 5 is an end view of the herb shears of FIG. 3, shown with the leaf stripper forming a small intermediate channel.

FIG. 6 is an end view of the herb shears of FIG. 3, shown with the leaf stripper forming a smallest sized channel.

FIG. 7 is an exploded view of a preferred pair of herb shears.

FIG. 8 is a top plan view of a preferred pair of herb shears, shown in the process of stripping a representative herb.

### DETAILED DESCRIPTION OF THE PREFERRED EMBODIMENT

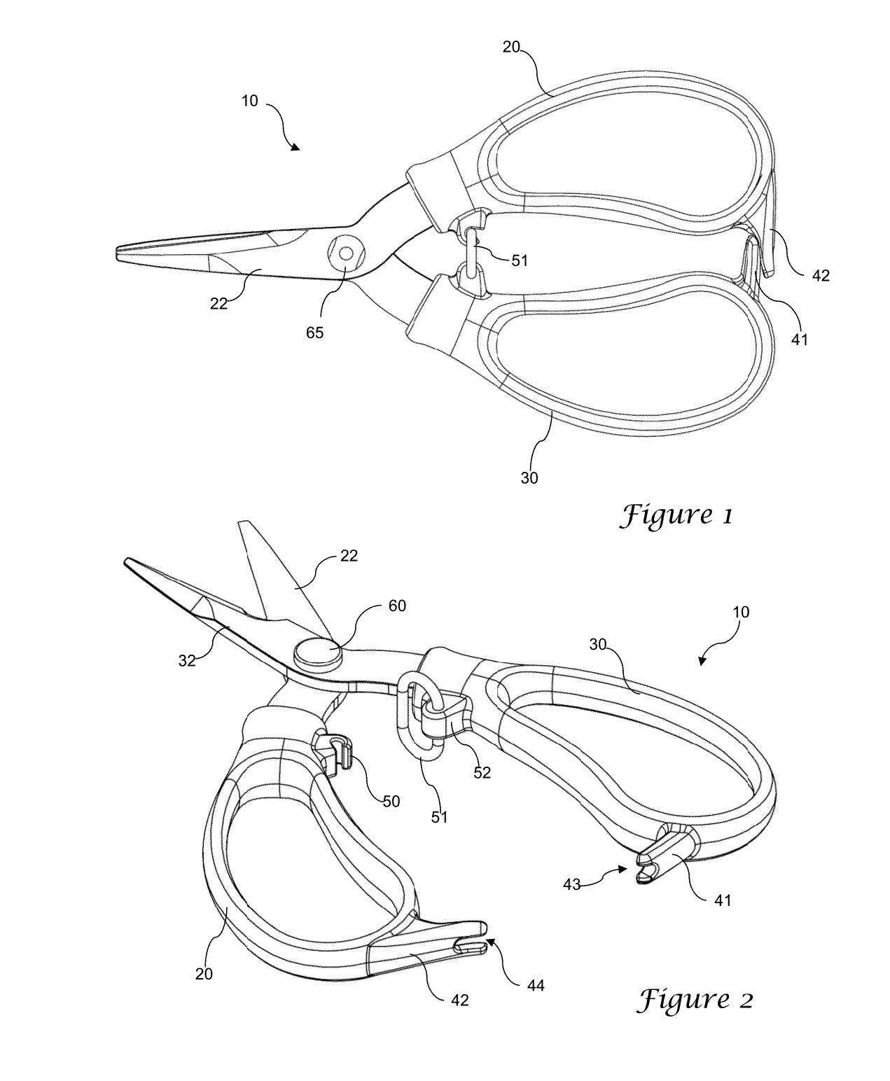

A preferred pair of herb shears is illustrated in top plan view in FIG. 1 and in perspective view in FIG. 2. In accordance with a preferred version of the invention, the shears 10 are formed by a pair of opposing blades 22, 32, each of which is integrally formed with a corresponding handle configured as a finger ring 20, 30. In the illustrated version the finger rings are elongated to accommodate more than one finger in each ring, though in alternate versions the finger rings may be smaller, and designed for a single finger. Likewise, in yet other versions the scissors blades may each terminate in a handle that is configured for grasping but which does not include a finger ring. The blades are attached to one another at a pivot point 60 to enable scissors cutting action by moving the blades apart and toward one another about the pivot point.

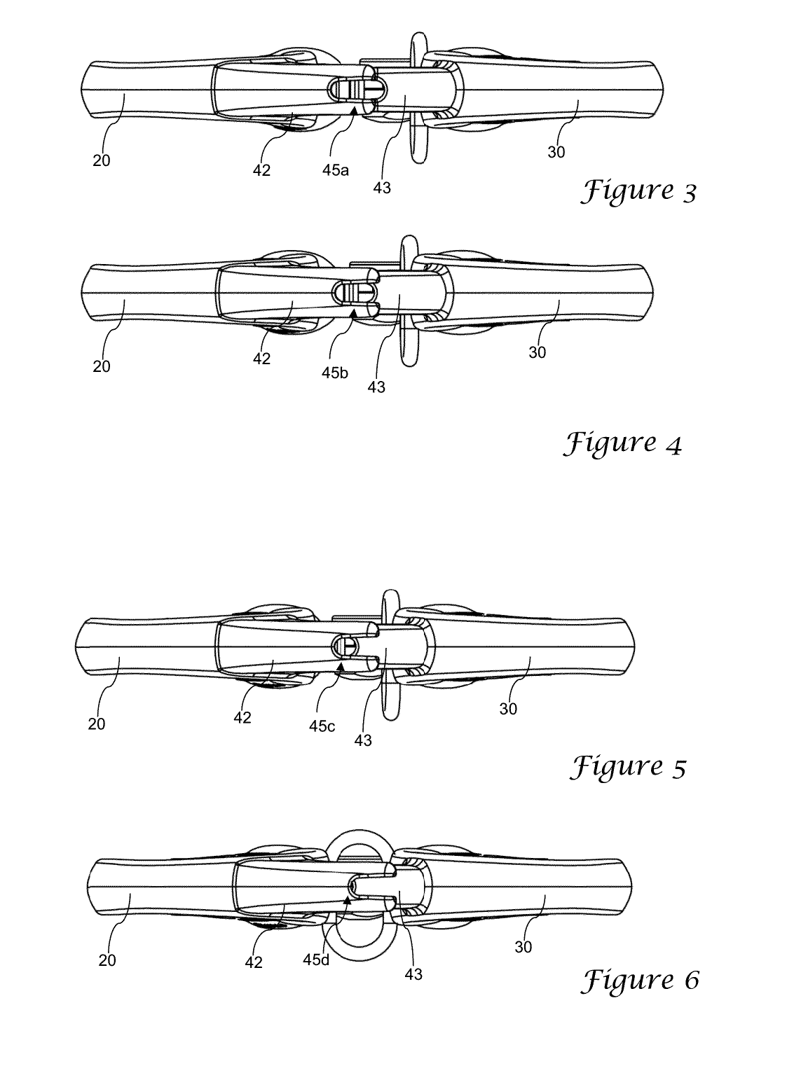

The handles 20, 30 include a leaf-stripping feature, preferably formed at a proximal end of the handle, with the proximal end being defined as the end of the handles farthest away from the pivot point 60 (and thus the distal end of the handles will be relatively closer to the pivot point). The preferred leaf stripper is configured as a closed channel 45 (as best seen in FIGS. 3-6) that is formed by complementary shapes positioned on each of the two handles 20, 30. In the preferred version, the closed channel 45 is formed by a pair of opposing prongs forming open channels 43, 44 which, when joined together, form a closed channel 45.

As illustrated, the closed channel is formed by a pair of prongs, each of which is formed on a post 41, 42 mounted to the handles 20, 30. Most preferably, each post is inwardly-directed such that the post 42 on the first handle 20 extends toward the second handle 30, and the post 41 on the second handle 30 extends toward the first handle 20 when the two handles are positioned adjacent one another in the closed position such as illustrated in FIG. 1 (with the blades thereby also being pivoted to a closed position fully adjacent one another). In alternate versions the leaf-stripping channel may be formed with different mating shapes, such as an open channel formed on one handle that mates with a flat or slightly rounded surface carried on the other channel.

Preferably, the posts 41, 42 carrying the open channels 43, 44 are axially offset from one another such that one of the posts 41 is slightly closer to the proximal end of the scissors (and likewise closer to the pivot point 60) than is the other post 42. The resulting overlying arrangement allows the posts to slide along one another, thereby allowing for controlled variability in the size of the closed channel 45 formed by the combination of the two closed channels 43, 44. As shown in the illustrations, the prongs on the posts are preferably long enough to form a large oval or oblong shaped channel 45a (see FIG. 3), one or more intermediate sized channels 45b, 45c, (see FIGS. 4 and 5) and a very small channel 45d (see FIG. 6). The variation in the channel size allows for the accommodation of stems of different sizes, and likewise allows the user to increase or decrease the pressure asserted against a single stem that varies in diameter along its length.

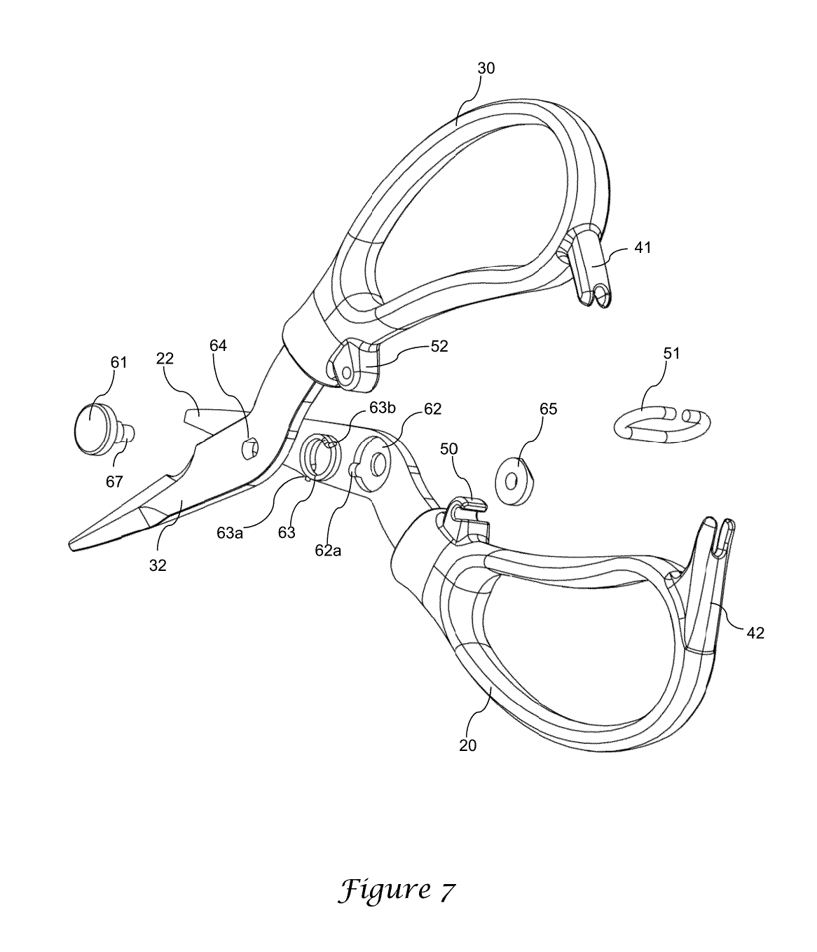

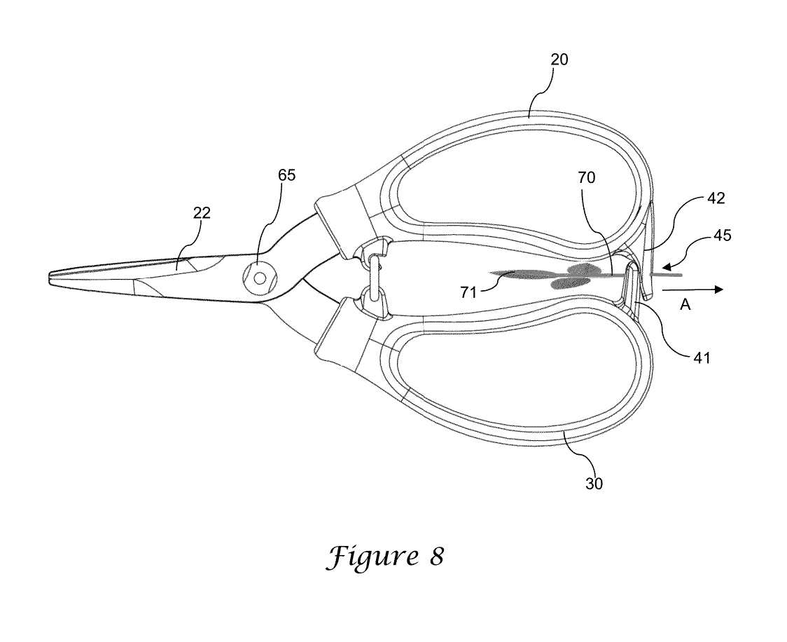

The preferred version of the scissors is formed with a spring positioned to assert a force urging the handles (and therefore the blades) apart from one another, as best seen in FIG. 7. Preferably a coil spring 63 is formed with a pair of terminal ends 63a, 63b that are angled radially outward from the short cylinder formed by the coil. The spring is positioned within a recess 62 formed within the scissor halves, with the terminal ends 63a, 63b of the spring being positioned within grooves 62a formed within the outer sidewalls of the recesses 62. In the exploded view of FIG. 7, one such recess 62 and groove 62a is shown; the opposing scissor handle 30 preferably is formed with a similar shape (that is, a recess having a groove) to receive and retain the coil spring 63 and the second terminal end 63b of the spring within the corresponding groove.

The scissor halves are joined together about the coil spring by an axle 67 having an integrated cap 61, which may be in the form of a screw, bolt or rivet in various versions of the invention. A mating nut 65 or other retaining cap 65 is provided on the opposite side of the scissors to secure the axle in place.

The spring and terminal ends are positioned within the scissor halves under a pre-biased force configured to urge the handles into an open position (such as the position shown in FIG. 2), thereby requiring a user to impart a force to compress the spring and bring the handles close to one another and into a closed position (such as the position shown in FIG. 1). This allows the user to better control the size of the closed channel 45 and to provide a resistance against squeezing too hard and closing the channel to the point of doing damage to the herbs as leaves are being stripped.

Because of the spring biasing the scissors to the open position, in one version the scissors may include a lock, such as an optional hook 50 and ring 51 positioned on opposing handle portions to hold the scissors in a closed position for storage. In the illustrated version, the ring is formed on a post 52 mounted on one of the two handles at a location between the pivot point and the distal end of the handle while the hook 50 is positioned on the opposing handle between the pivot point and the distal end of the handle. In other versions, alternate clips, hooks, or other closing mechanisms may be used.

In use, such as shown in FIG. 8, a leafy stem 70 having one or more leaves 71 is positioned between the open channels carried on the posts 41, 42 attached to the handles. The handles are pivoted toward one another to form the closed channel 45, in which the closed channel 45 is sized as appropriate to surround and abut the stem 70. The user urges the channels toward one another to apply a desired amount of force on opposing sides of the stem in order to strip away the leaves as the stem is pulled through the channel. Once positioned within the channel, the stem is pulled through the channel (preferably in the direction of the arrow A in FIG. 8), thereby stripping away the leaves as the stem is pulled through. This action separates the leaves from the stems so that the leaves may be used separately in cooking.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A pair of herb shears, comprising:
a first blade attached to a first handle having a distal end and a proximal end;
a second blade attached to a second handle having a distal end and a proximal end, the first blade being joined to the second blade at a pivot point adjacent the proximal end of the first handle and the proximal end of the second handle, the first blade being pivotable with respect to the second blade between an open position in which the blades are apart from one another and a closed position in which the blades are adjacent one another;
a first pair of prongs forming a first open channel extending from the first handle toward the second handle; and
a second pair of prongs forming a second open channel extending from the second handle toward the first handle;
whereby the first pair of prongs and the second pair of prongs cooperate to form a closed channel when the first handle is pivoted toward the second handle.

2. The herb shears of claim 1, wherein the first pair of prongs is relatively closer to the pivot point than the second pair of prongs is to the pivot point when the shears are pivoted to the closed position.

3. The herb shears of claim 1, further comprising a first post extending from the first handle, the first pair of prongs being formed on the first post.

4. The herb shears of claim 3, further comprising a second post extending from the second handle, the second pair of prongs being formed on the second post.

5. The herb shears of claim 4, further comprising a lock positioned between the pivot point and the distal end of the first handle, the lock being configured to hold the shears in the closed position.

6. The herb shears of claim 5, wherein the lock comprises a hook attached to the first handle and a ring attached to the second handle, the hook being configured to releasably retain the ring.

7. The herb shears of claim 6, further comprising a spring attached to the shears, the spring being configured to bias the shears in the open position.

8. The herb shears of claim 7, further comprising a recess formed at the pivot point, the spring being trapped within the recess.

9. The herb shears of claim 8, further an axle extending through the first blade and the second blade at the pivot point, the spring being carried on the axle.

10. The herb shears of claim 1, wherein the first handle is formed as a finger ring.

11. A pair of herb shears, comprising:
a first blade attached to a first handle having a distal end and a proximal end;
a second blade attached to a second handle having a distal end and a proximal end, the first blade being joined to the second blade at a pivot point adjacent the proximal end of the first handle and the proximal end of the second handle, the first blade being pivotable with respect to the second blade between an open position in which the blades are apart from one another and a closed position in which the blades are adjacent one another;
a first set of prongs forming a first open channel extending from the first handle toward the second handle, the first set of prongs being configured to engage an opposing surface formed on the second handle to form a closed channel when the first handle is pivoted toward the second handle.

12. The herb shears of claim 11, wherein the opposing surface formed on the second handle comprises a post.

13. The herb shears of claim 11, wherein the opposing surface formed on the second handle comprises a second set of prongs.

14. The herb shears of claim 13, wherein first set of prongs is formed on a post extending from the first handle.

15. The herb shears of claim 14, wherein second set of prongs is formed on a post extending from the second handle.

16. The herb shears of claim 15, wherein the first set of prongs overlaps the second set of prongs when the shears are pivoted to the closed position.

17. The herb shears of claim 16, further comprising a lock positioned between the pivot point and the distal end of the first handle, the lock being configured to hold the shears in the closed position.

18. The herb shears of claim 17, further comprising a spring attached to the shears, the spring being configured to bias the shears in the open position.
